(19) United States
(12) Patent Application Publication
(10) Pub. No.: US 2009/0233163 A1
(43) Pub. Date: Sep. 17, 2009

(54) BATTERY ASSEMBLY BRACKET

(76) Inventors: Yo-Fu Fang, Taipei City (TW); Tung Lung Chou, Taipei City (TW); Chun-Chu Lin, Taipei City (TW)

Correspondence Address: SINORICA, LLC, 2275 Research Blvd., Suite 500, ROCKVILLE, MD, 20850, US

(21) Appl. No.: 12/112,682

(22) Filed: Apr. 30, 2008

(30) Foreign Application Priority Data
Mar. 11, 2008 (TW) 97204113

(51) Int. Cl. H01M 2/10

(52) U.S. Cl. 429/99

(57) ABSTRACT

The present invention discloses a battery assembly bracket, which comprises a hollow casing having accommodation spaces accommodating battery cells. The edges of every two opposite faces of the hollow casing have convex strips and engagement slots, whereby a plurality of hollow casings can be assembled together. Four corners of one bottom face of the hollow casing have fixing elements, whereby the battery assembly bracket can be fixed to a printed circuit board. The battery assembly brackets of the present invention can be flexibly assembled into different battery modules having different numbers of cells, different voltages and different capacities to satisfy different systems. The battery assembly bracket of the present invention not only can simplify battery assembly and reduce assembly manpower but also can decrease the number of molds, lower the fabrication cost and increase the economic benefits.

### BACKGROUND OF THE INVENTION

1. Field of the Invention

The present invention relates to a battery assembly bracket, particularly to a battery assembly bracket, which can flexibly cascades or parallels different numbers of battery cells, whereby battery cells can be conveniently configured and easily assembled to satisfy various applications.

2. Description of the Related Art

Lithium batteries have been widely used in consumer electronics because of its high capacity, high charge/discharge efficiency, and long service life. The technologies of lithium batteries also have greatly advanced in recent years to meet the market, such as the technologies for safety and high current capability. The current trend of lithium batteries is toward medium or large size, and the potential markets include: vehicle batteries (mainly for electric vehicles), industrial machines (electric tools), and energy storage devices (for notebook computers). In the field of light-duty electric vehicles, such as electric bikes and electric motorcycles, the performance of batteries and the environment for charging batteries still have many problems to overcome.

Currently, the devices needing high current and high power output, such as light-duty vehicles, usually adopt two 12V batteries as the basic power supply unit. If necessary, several basic power supply units are cascaded to obtain a higher voltage (mainly 24V). Batteries of this type are much cheaper than other types of batteries. However, such a type of power supply system has some intrinsic defects to overcome, such as bulkiness and low space efficiency, especially in the cascaded batteries, which reduces the flexibility of car body design. Besides, a lead-acid battery is very heavy, which decreases the energy efficiency of the motor and the endurance of the battery. Further, charging a lead-acid is very time-consuming. Therefore, the lead-acid battery lacks economic efficiency and competitiveness. As for the cascaded lithium battery module, the cells thereof need an assembly module or casing, which increases the cost of molds. Besides, the assembly module should be able to overcome impact or vibration, which may cause the collision or drop of cells. Further, the assembly module should be able to overcome the electrical/thermal insulation of cells.

Thus, the manufacturers should pay attention to improving the simplicity and efficiency of assembling battery modules to lower the fabrication cost and increase the economic benefits.

### SUMMARY OF THE INVENTION

One objective of the present invention is to provide a battery assembly bracket, which can simplify and convenience battery assembly, reduce assembly manpower, and promote assembly efficiency, and which can also decrease the number of molds, lower the fabrication cost and increase the economic benefits.

Another objective of the present invention is to provide a battery assembly bracket, which achieves unlimited expandability via flexibly assembling identical-structure hollow casings to accommodate different numbers of battery cells.

Further objective of the present invention is to provide a battery assembly bracket, which prevents battery cells from collision and drop and electrically/thermally insulates battery cells, whereby the security and reliability of a battery assemblage is enhanced.

To achieve the abovementioned objectives, the present invention proposes a battery assembly bracket comprising a hollow casing. The hollow casing has accommodation spaces used to accommodate battery cells. Convex strips and engagement slots are formed in the edges of every two opposite faces of the hollow casing. Positioning block plates having positioning holes are respectively arranged at four corners of one bottom face of the hollow casing. In packing, the bottoms of battery cells are packed into one battery assembly bracket, and then another battery assembly bracket hoods the tops of the battery cells. Further, a sleeve element may cooperate with the hollow casing to enhance the security of the packed battery assembly bracket. Then, the packed battery assembly brackets are assembled together via the engagement of the convex strips and engagement slots.

Below, the present invention is described in detail to make easily understood the technical contents of the present invention.

### BRIEF DESCRIPTION OF THE DRAWINGS

FIG. 1A is a perspective view schematically showing the structure of a battery assembly bracket according to the present invention;

FIG. 1B is another perspective view schematically showing the structure of a battery assembly bracket according to the present invention;

FIG. 2 is an exploded view schematically showing a first embodiment of the present invention;

FIG. 3 is a perspective view schematically showing a packed battery assembly bracket in the first embodiment of the present invention;

FIG. 4A is a perspective view schematically showing the structure of a sleeve element in the first embodiment of the present invention;

FIG. 4B is another perspective view schematically showing the structure of a sleeve element in the first embodiment of the present invention;

FIG. 5 is an exploded view schematically showing that a sleeve element is additionally used in the first embodiment of the present invention;

FIG. 6 is a perspective view schematically showing a packed battery assembly bracket containing a sleeve element in the first embodiment of the present invention;

FIG. 7 is an exploded view schematically showing a second embodiment of the present invention;

FIG. 8 is a perspective view schematically showing a packed battery assembly bracket in the second embodiment of the present invention;

FIG. 9 is an exploded view schematically showing that a sleeve element is additionally used in the second embodiment of the present invention;

FIG. 10 is a perspective view schematically showing a packed battery assembly bracket containing a sleeve element in the second embodiment of the present invention;

FIG. 11 is an exploded view schematically showing the steps of assembling the packed battery assembly brackets in the first embodiment of the present invention;

FIG. 12 is a perspective view schematically showing the assemblage of the packed battery assembly brackets in the first embodiment of the present invention;

FIG. 13 is an exploded view schematically showing the steps of assembling the packed battery assembly brackets in the second embodiment of the present invention;

FIG. 14 is a perspective view schematically showing the assemblage of the packed battery assembly brackets in the second embodiment of the present invention;

FIG. 15 is an exploded view schematically showing the steps of packaging a battery module in the second embodiment of the present invention; and

FIG. 16 is a perspective view schematically showing the package of a battery module in the second embodiment of the present invention.

### DETAILED DESCRIPTION OF THE INVENTION

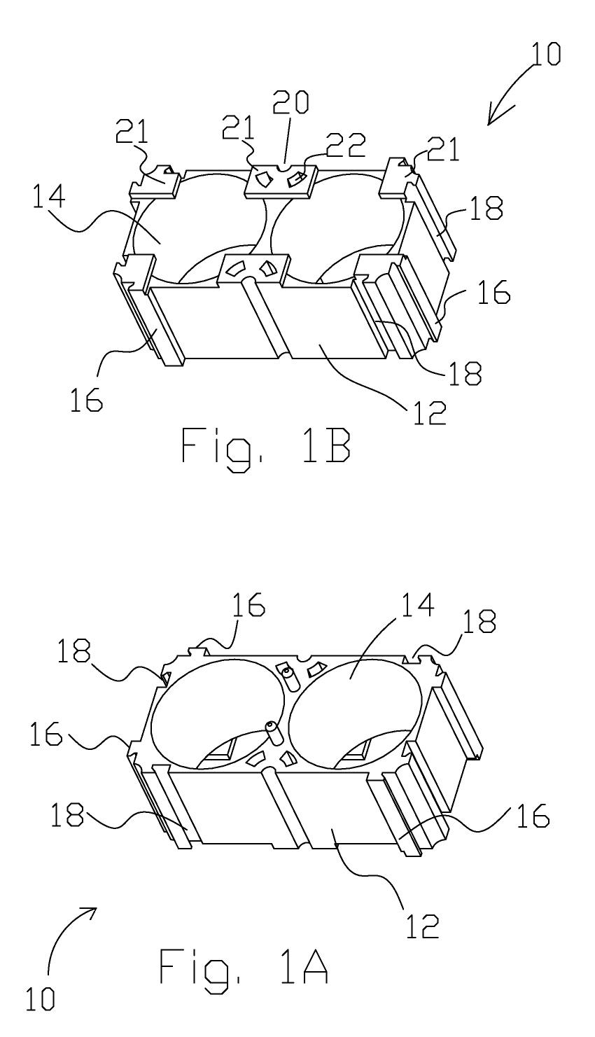

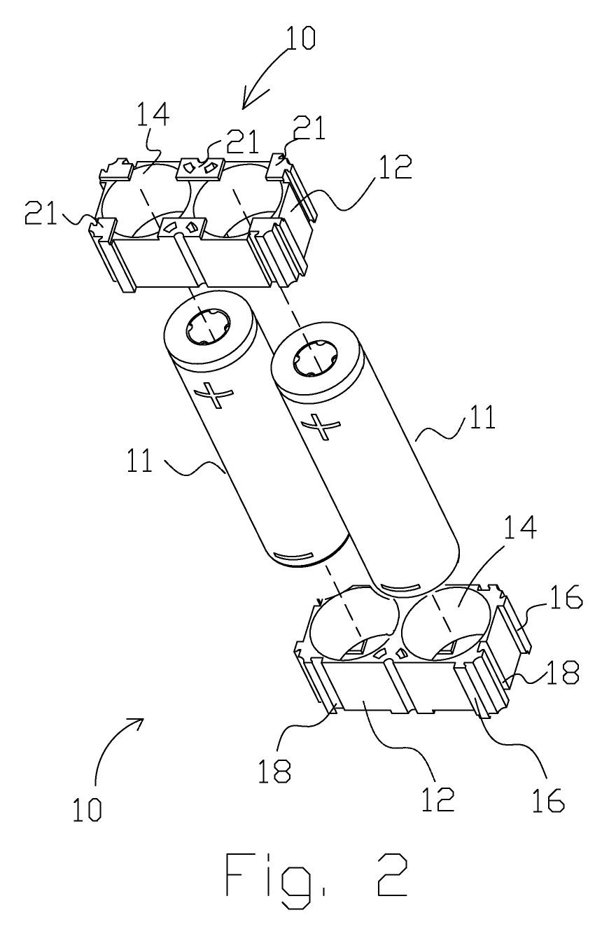

Refer to FIG. 1A, FIG. 1B and FIG. 2 for a first embodiment of the present invention, wherein a battery assembly bracket for two Li-polymer battery cells is used to exemplify the first embodiment. In this embodiment, the battery assembly bracket 10 has a hollow casing 12. The hollow casing 12 has accommodation spaces 14 used to accommodate battery cells 11. The accommodation space 14 is adapted to the shape and dimensions of the battery cell 11. In this embodiment, a cylindrical battery cell is used. Convex strips 16 and engagement slots 18 are formed in the edges of every two opposite faces of the hollow casing 12. The convex strips 16 and engagement slots 18 on two opposite faces of the hollow casing 12 are diagonally symmetric. In other words, if they are arranged in an order of convex strip 16-engagement slot 18 on one face, they are arranged in an order of engagement slot 18-convex strip 16 on the opposite face. The hollow casing 12, the convex strips 16 and the engagement slots 18 may be fabricated into a one-piece part via an injection molding process. The convex strips 16 and engagement slots 18 may be arranged to be parallel or vertical to the top of the hollow casing 12. In this embodiment, the convex strips 16 and engagement slots 18 are arranged to be vertical to the top of the hollow casing 12. In the hollow casing 12, four fixing elements 20 are respectively arranged at four corners of one bottom face of the hollow casing 12. The fixing element 20 is a small positioning block plate 21 having positioning holes 22. The hollow casing 12 may be made of an insulating material, such as ABS (Acrylonitrile Butadiene Styrene), PVC (Polyvinylchloride), ABS+PVC, or nylon.

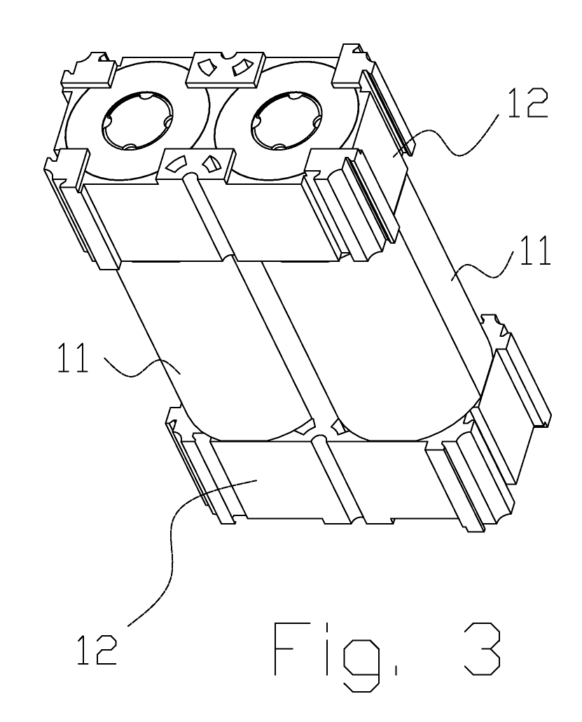

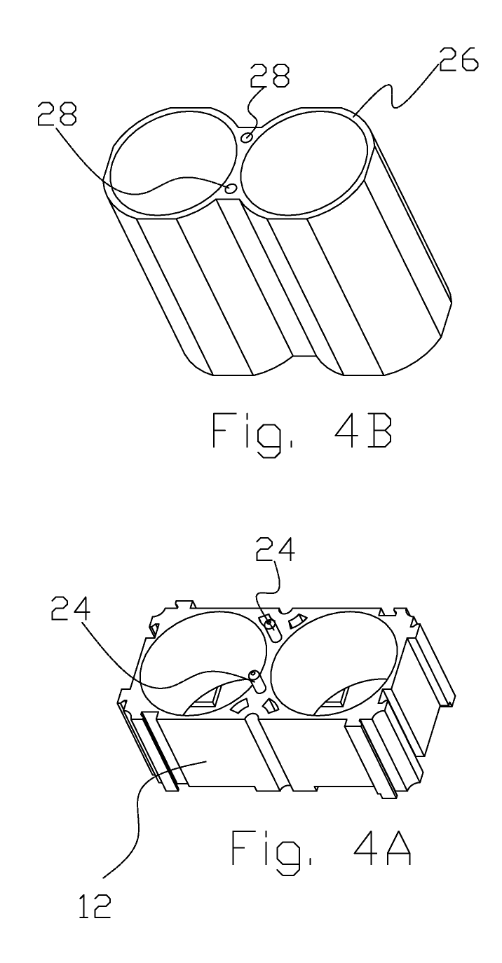

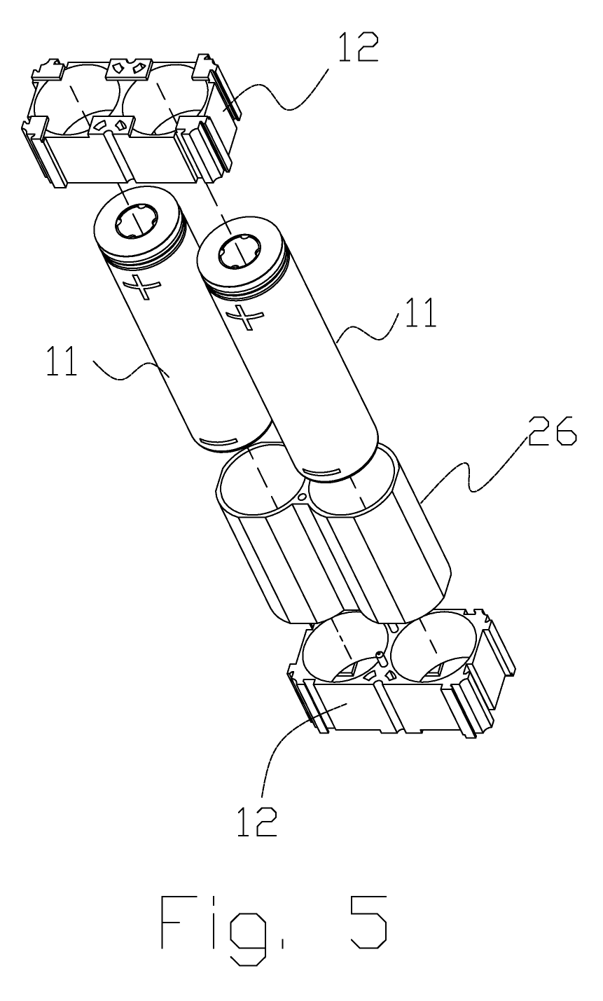

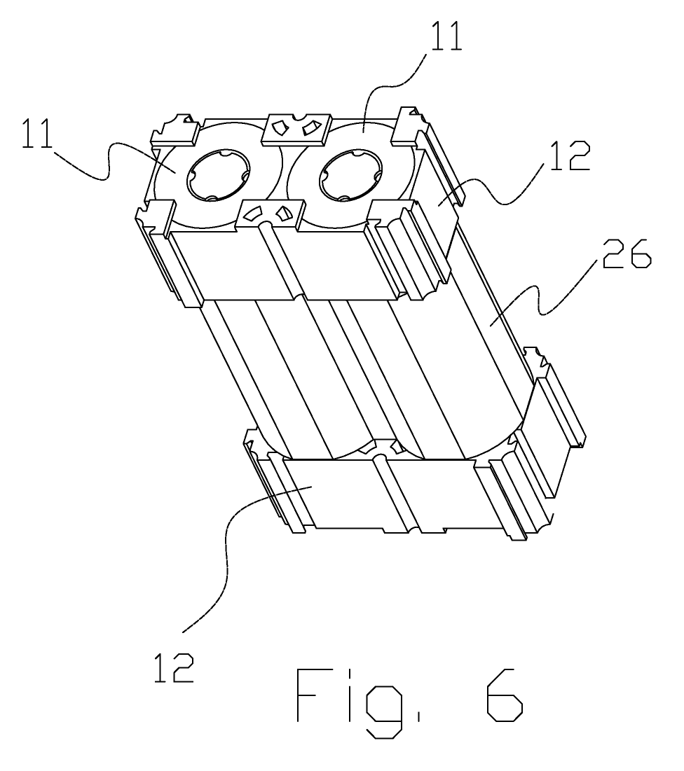

Refer to FIG. 3. In packing, the battery cell 11 is pushed into the accommodation space 14 until the top and bottom of the battery cell 11 press against the positioning block plates 21. Refer to FIG. 4A, FIG. 4B and FIG. 5. A sleeve element 26 may cooperate with the hollow casing 12. The sleeve element 26 is adapted to the number, shape and dimensions of the battery cells 11. The sleeve element 26 may be made of an insulating material, such as ABS (Acrylonitrile Butadiene Styrene), PVC (Polyvinylchloride), ABS+PVC, or nylon. The cooperation of the hollow casing 12 and sleeve element 26 can enhance the security of the battery cell pack and the electrical/thermal insulation of the battery cells 11. The top face of the hollow casing 12 has pillars 24. The pillars 24 and the hollow casing 12 may be fabricated into a one-piece part via an injection molding process. The top and bottom of the sleeve element 26 have fixing holes 28 corresponding to the pillars 24 of the hollow casing 12. The engagement of the pillars 24 and fixing holes 28 joins together the sleeve element 26 and hollow casing 12. Refer to FIG. 6. Via packing the battery cells 11 into the hollow casing 12 and sleeve element 26, the battery cells 11 are secured reliably, and the electrical/thermal insulation of the battery cells 11 is enhanced.

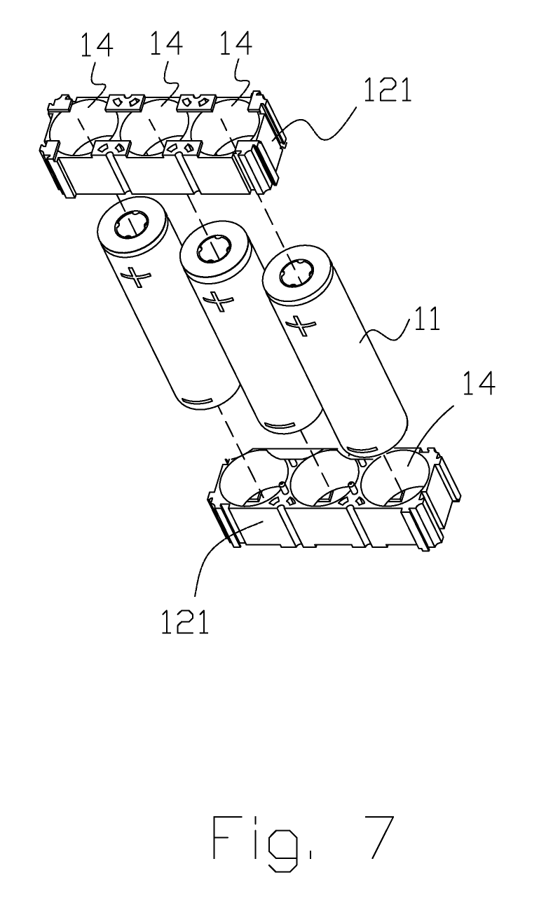

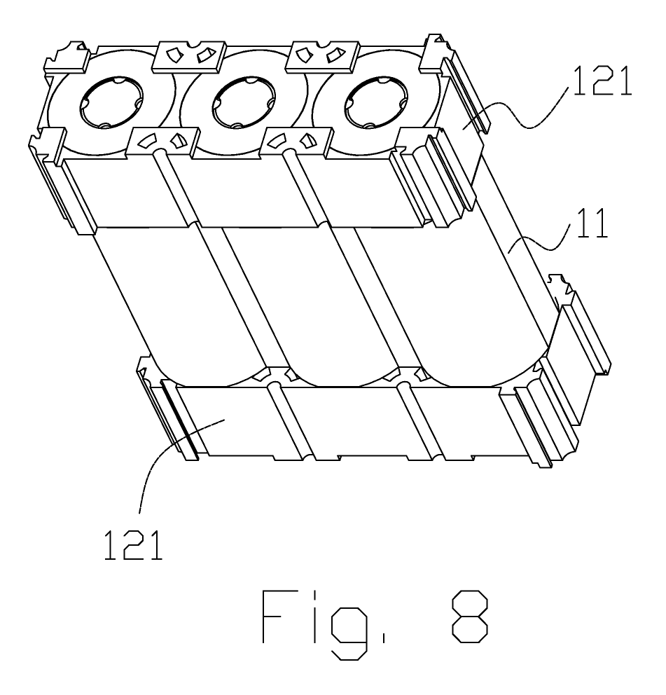

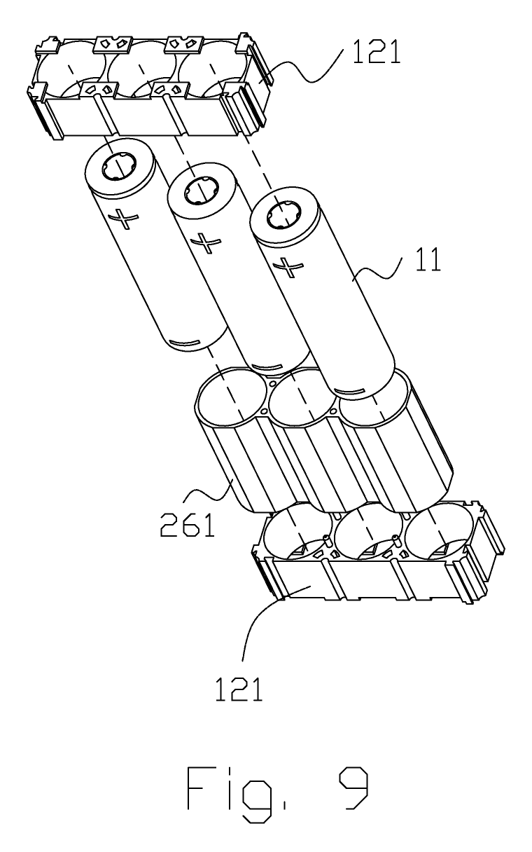

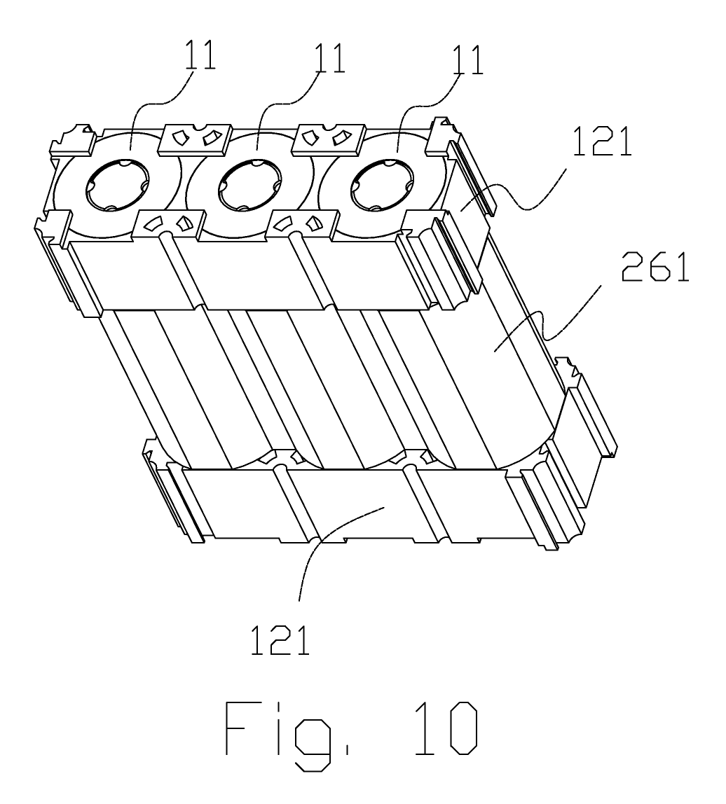

Refer to from FIG. 7 to FIG. 10 for a second embodiment of the present invention, wherein a battery assembly bracket for three battery cells is used to exemplify the second embodiment. All the technical features and assembling steps of the second embodiment are similar to those of the first embodiment except the hollow casing 121 has three accommodation spaces 14 to accommodate three battery cells 11. In the second embodiment, a sleeve element 261 is used to achieve the same function as in the first embodiment.

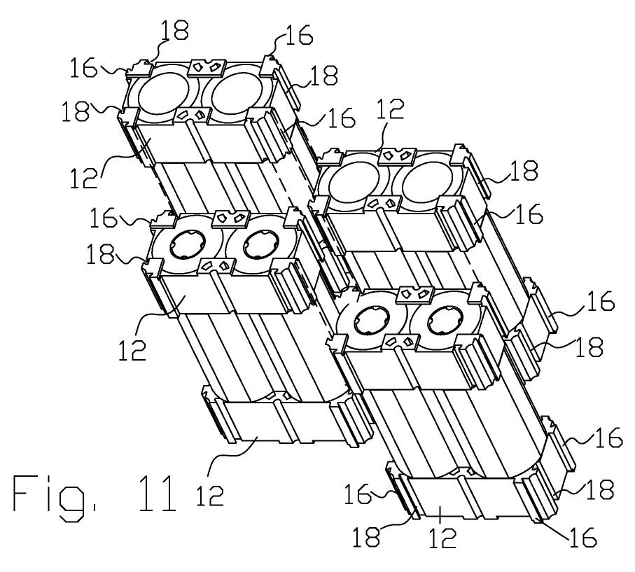

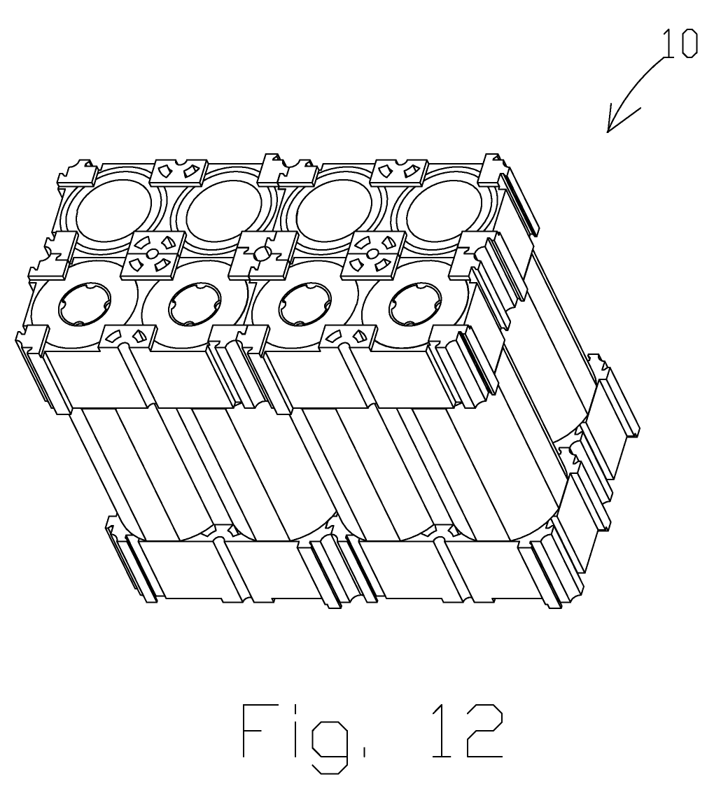

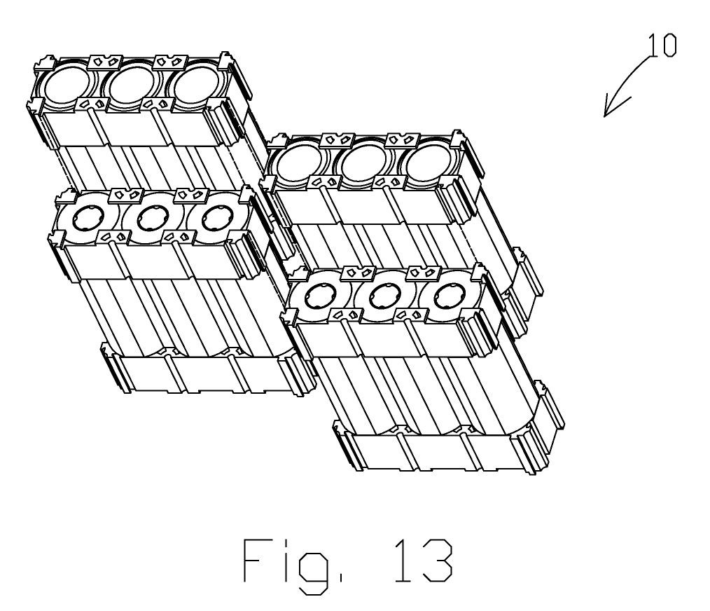

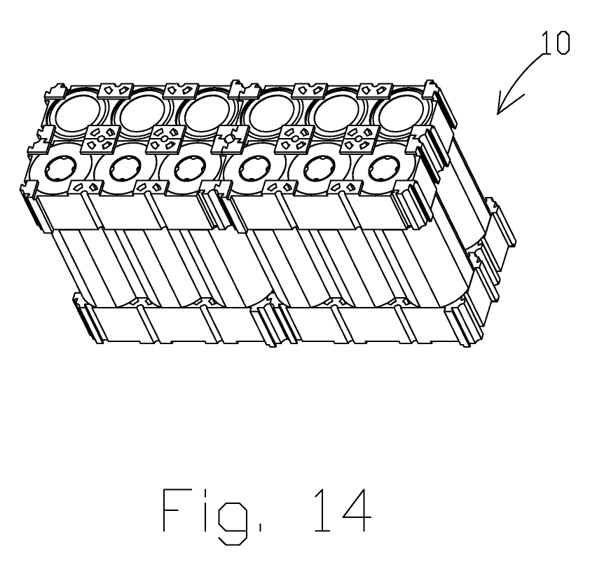

In the abovementioned two embodiments, the hollow casings 12 can be assembled via the engagement of the convex strips 16 and engagement slots 18. Refer to FIG. 11 for the steps of assembling the packed battery assembly brackets 10 in the first embodiment, and refer to FIG. 12 for the assemblage of the packed battery assembly brackets in the first embodiment. The convex strip 16 and engagement slot 18 on one face of one packed battery assembly bracket 10 are parallel slid into the engagement slot 18 and convex strip 16 on one face of another packed battery assembly bracket 10 to engage the two packed battery assembly brackets 10 together. Every face of the hollow casing 12 has the convex strips 16 and engagement slots 18. Therefore, the hollow casings 12 can be infinitely assembled without the limitation of number and direction. Refer to FIG. 13 and FIG. 14. The battery assembly brackets 10 of the second embodiment can also be assembled in the same way, and the steps thereof will not repeat herein.

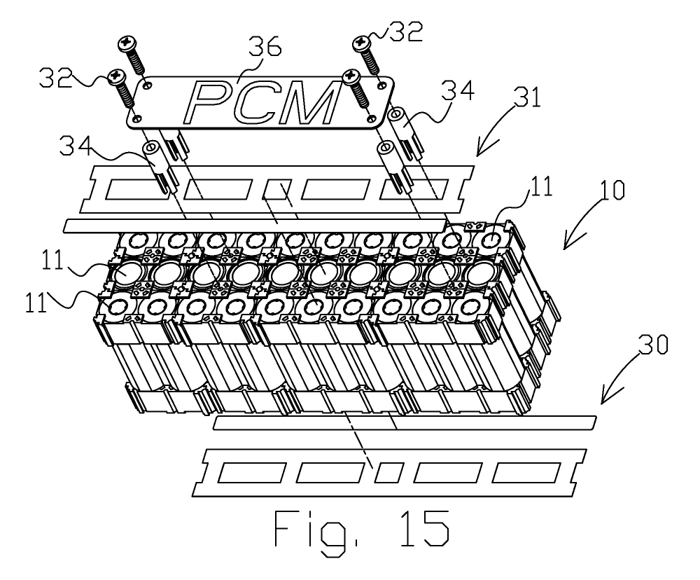

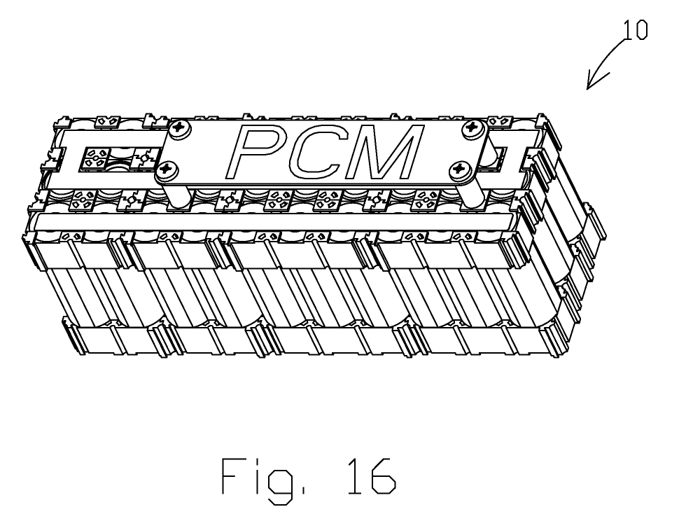

Refer to FIG. 15. After the assemblage of the battery assembly brackets 10 is completed, metallic conduction plates 30 and 31, such as nickel plates, are respectively installed on the top face and bottom face of the hollow casings 12 to respectively contact the positive and negative electrodes of the battery cells 11. The metallic conduction plates 30 and 31 may be fixed via spot welding. Thereby, the battery cells 11 are connected in series. Then, a fixing plate 36 is fixed to the positioning holes 22 of the positioning block plate 21 with screws 32 and joint bolts 34. As shown in FIG. 16, the package of the battery assembly brackets 10 is thus completed.

Via only a single type of casings, the present invention can achieve the configuration flexibility and assembly simplification of battery cells, improve the assembly efficiency, reduce the assembly cost, and promote the economic benefits.

From the above description, it is proved that the present can really simplify the assembly procedures of batteries, and that the present invention is indeed a superior innovation. Thus, the Inventor files the application for a patent.

The preferred embodiments described above are only to exemplify the present invention but not to limit the scope of the present invention. Therefore, any equivalent modification or variation according to the spirit of the present invention is to be also included within the scope of the present invention.

What is claimed is:

1. A battery assembly bracket, comprising:
a hollow casing, having accommodation spaces thereinside to accommodate battery cells, having convex strips and engagement slots in edges of two opposite faces thereof, and having fixing elements at four corners of one bottom face thereof.

2. The battery assembly bracket according to claim 1, wherein said hollow casing, said convex strips and said engagement slots are fabricated into a one-piece part via an injection molding process.

3. The battery assembly bracket according to claim 1, wherein said accommodation space is adapted to size and shape of a battery cell, and said shape is a circle, a rectangle, a triangle, or a polygon.

4. The battery assembly bracket according to claim 1, wherein said convex strips and said engagement slots are arranged in edges of two opposite faces of said hollow casing and parallel or vertically to one end of said hollow casing.

5. The battery assembly bracket according to claim 1, wherein said convex strips and said engagement slots are extended to a top face and a bottom face of said casing.

6. The battery assembly bracket according to claim 1, wherein said fixing element is a small positioning block plate having at least one positioning hole.

7. The battery assembly bracket according to claim 6, wherein said hollow casing is fixed to a printed circuit board via inserting joint bolts into said positioning holes.

8. The battery assembly bracket according to claim 1, wherein a plurality of said battery assembly bracket each accommodating a plurality of battery cells is assembled together via engaging said convex strips and said engagement slots of said hollow casings.

9. The battery assembly bracket according to claim 1, wherein said hollow casing is made of an insulating material, and said insulating material is ABS (Acrylonitrile Butadiene Styrene), PVC (Polyvinylchloride), ABS+PVC, or nylon.

10. The battery assembly bracket according to claim 1, wherein a top face of said hollow casing has pillars used to install a sleeve element.
